(19) United States
(12) Patent Application Publication
(10) Pub. No.: US 2026/0213342 A1
(43) Pub. Date: Jul. 23, 2026

(54) Polymer-Coated Separator With Secondary Agglomerates, Preparation Method Therefor, and Battery

(71) Applicant: SINOMA LITHIUM BATTERY SEPARATOR CO., LTD., Zaozhuang, Shandong (CN)

(72) Inventors: Jing SUN, Zaozhuang, Shandong (CN); Yaozong BAI, Zaozhuang, Shandong (CN); Gaojun LIU, Zaozhuang, Shandong (CN); Lei ZHENG, Zaozhuang, Shandong (CN); Feifei GAO, Zaozhuang, Shandong (CN); Tian LI, Zaozhuang, Shandong (CN); Wenjuan QIN, Zaozhuang, Shandong (CN)

(73) Assignee: SINOMA LITHIUM BATTERY SEPARATOR CO., LTD., Zaozhuang, Shandong (CN)

(21) Appl. No.: 18/715,627

(22) PCT Filed: Aug. 10, 2023
(86) PCT No.: PCT/CN2023/112149

§ 371 Date: May 31, 2024

(30) Foreign Application Priority Data
May 4, 2023 (CN) 202310483037.3

(51) Int. Cl. H01M 50/426; H01M 50/449

(52) U.S. Cl. CPC H01M 50/426; H01M 50/449

(57) ABSTRACT

The present invention discloses a polymer-coated separator with secondary agglomerates, a preparation method therefor, and a battery. The polymer-coated separator includes a separator substrate, and a polymer coating applied on a surface of at least one side of the separator substrate, wherein the polymer coating includes a plurality of randomly distributed spray coating points, the spray coating points including a plurality of polymer secondary agglomerates formed by agglomeration of polymer primary particles; any one spray coating point in the polymer coating satisfies the following conditions: 25≤A/B≤40000, and 100≤C/A≤10⁶, wherein A represents a projected area of the polymer secondary agglomerates on the separator substrate; B represents a projected area of the polymer primary particles on the separator substrate; and C represents a projected area of the spray coating point on the separator substrate.

### TECHNICAL FIELD

The present invention relates to the technical field of battery separators, in particular to a polymer-coated separator with secondary agglomerates, a preparation method therefor, and a battery.

### BACKGROUND

In recent years, with the rapid growth of power vehicle sales, the demand for power lithium-ion batteries has significantly increased, and data shows that lithium-ion batteries will continue to maintain a higher rate of rise in the future with the development of the demand industry for lithium-ion batteries. With the increasing demand for lithium-ion batteries, the market has higher and higher requirements for the performance of the lithium-ion batteries, which in turn puts forward higher requirements for lithium-ion battery separators.

Separators of ordinary lithium-ion batteries are almost non-bonded to electrode pieces, which leads to easy detachment of lithium-ion batteries during charging and discharging, thereby reducing the cycle life of the batteries. In view of the above problems, the existing treatment method is to coat one or both sides of a separator with a polymer coating having adhesion properties, wherein the polymer can be polyvinylidene fluoride (PVDF) or polymethyl methacrylate (PMMA). However, while existing polymer coatings improve the adhesion of the separators to the electrode pieces, most of the polymer coatings change pore structures of the separators, resulting in an increase in the internal resistance of batteries and a decrease in the charge-discharge rate of the batteries. Thus, balancing the adhesion and the permeability of the polymer coating to obtain a separator with the adhesion and permeability is very difficult.

### SUMMARY

In view of this, the present invention provides a polymer-coated separator with secondary agglomerates which has high adhesion, high permeability, and high electrolyte uptake and retention, a preparation method therefor, and a battery.

In order to achieve the above object, a first aspect of the present invention provides a polymer-coated separator with secondary agglomerates, including a separator substrate, and a polymer coating applied on a surface of at least one side of the separator substrate, wherein the polymer coating includes a plurality of randomly distributed spray coating points, the spray coating points including a plurality of polymer secondary agglomerates formed by agglomeration of polymer primary particles;
any one spray coating point in the polymer coating satisfies the following conditions:

25≤A/B≤40000, and 100≤C/A≤10⁶, wherein
A represents a projected area of the polymer secondary agglomerates within the spray coating point on the separator substrate;
B represents a projected area of the polymer primary particles within the spray coating point on the separator substrate; and
C represents a projected area of the spray coating point on the separator substrate; and
n×ΣA/S means a proportion of effective bonding area on the polymer coating, and satisfies: 4%≤n×ΣA/S≤50%, wherein S represents a surface area of the separator substrate;
ΣA represents the sum of projected areas of all polymer secondary agglomerates within the spray coating points on the separator substrate; and
n represents the number of the spray coating points within the area S.

According to any embodiment of the first aspect of the present invention, 25≤A/B≤10000, and 2500≤C/A≤5×10⁵; and

$$6 \% \leq n \times Σ A / S \leq 30 \% .$$

According to any embodiment of the first aspect of the present invention, the polymer coating has a thickness of 0.5-10 μm.

According to any embodiment of the first aspect of the present invention, the polymer-coated separator has a bonding strength of 1 N/m or more to a ternary positive electrode, and has a bonding strength of 0.5 N/m or more to a graphite negative electrode; and/or
the polymer-coated separator has an ionic conductivity of 80%-110% of an ionic conductivity of the separator substrate; and/or
the polymer-coated separator has an electrolyte uptake rate of 70% or more, and an electrolyte retention rate of 70% or more; and/or
the polymer-coated separator has a powder shedding rate of 5% or less.

According to any embodiment of the first aspect of the present invention, the polymer coating includes:
80-100 parts by mass a polymer with secondary agglomerates;
2-20 parts by mass a binder; and
0.01-3 parts by mass a dispersant.

According to any embodiment of the first aspect of the present invention, the polymer with the secondary agglomerates includes at least one selected from a polyvinylidene fluoride homopolymer (PVDF), a polyvinylidene fluoride-trifluoroethylene copolymer (PVDF-TrFE), a polyvinylidene fluoride-methyl methacrylate copolymer (PVDF-PMMA), a polyvinylidene fluoride-hexafluoropropylene copolymer (PVDF-HFP), a polyvinylidene fluoride-acrylic acid copolymer, polymethyl methacrylate (PMMA), polyethylene (PE), and an acrylate polymer.

According to any embodiment of the first aspect of the present invention, the binder includes at least one selected from carboxymethylcellulose, hydroxyethylcellulose, polyacrylic acid, polymethacrylic acid, polymethyl methacrylate, and an acrylonitrile multipolymer.

According to any embodiment of the first aspect of the present invention, the dispersant includes at least one selected from an ethylene-acrylic acid copolymer, an ethylene-vinyl acetate copolymer, acrylic acid-polyurethane, and polyethylene glycol.

According to any embodiment of the first aspect of the present invention, the separator substrate is selected from at least one of a polyethylene film, a polypropylene film, a polyimide film, a polyvinylidene fluoride film, a polyvinylidene fluoride-hexafluoropropylene film, a polyamide film, and a polyethylene terephthalate film.

According to any embodiment of the first aspect of the present invention, the separator substrate has a thickness of 3-25 μm, and a porosity of 20-80%.

A second aspect of the present invention provides a preparation method for the polymer-coated separator with the secondary agglomerates, including:
S01, uniformly mixing a dispersant with water, then adding a polymer in a batches, a mass of the polymer added each time being 1/a of a total amount, each time after adding the polymer, first performing slow stirring, then performing quick stirring and then performing slow stirring, until the polymer is completely added, wherein a≥2;
optionally performing grinding treatment, finally adding a binder, and performing uniform mixing and filtering to obtain a polymer slurry;
S02, coating a surface of at least one side of a separator substrate with the polymer slurry by means of spin spraying to obtain a polymer coating, wherein spin spraying parameters: a coating speed of 100 m/min-300 m/min, a slurry spraying flow rate being 1500 mL/min-15000 mL/min, a rotational speed of the spraying being 5000 rpm-15000 rpm, the number of teeth of a rotary disc for the spraying being 200 teeth to 600 teeth, and a distance from the rotary disc to a membrane surface being 20 cm-50 cm; and
S03, drying the separator substrate and the polymer coating to obtain the polymer-coated separator with the secondary agglomerates.

According to any embodiment of the second aspect of the present invention, the step S01 includes:
S011, uniformly mixing the water with the dispersant to obtain a first mixed solution;
S012, adding the polymer into the first mixed solution in a batches, the amount of the polymer added each time being 1/a of the total amount, after each addition, performing first-stage dispersion: wherein a stirring rotational speed is 100 rpm-600 rpm, and a stirring time is 10 min-50 min, and then performing second-stage dispersion: wherein a stirring rotational speed is 1000 rpm-2000 rpm, and a stirring time is 30 min-180 min, and finally performing third-stage dispersion: wherein a stirring rotational speed is 100 rpm-600 rpm, and a stirring time is 10 min-50 min, until the polymer is completely added to obtain a second mixed solution; and
S013, adding the binder into the second mixed solution, performing uniform stirring, and performing filtering through a 40-300-mesh filter to obtain the polymer slurry.

According to any embodiment of the second aspect of the present invention, the polymer slurry has a particle size D10 of 1-4 μm and a particle size D90 of 6-20 μm. According to any embodiment of the second aspect of the present invention, the polymer coating amount is 0.05-1.5 g/m².

According to any embodiment of the second aspect of the present invention, the drying in the step S03 is performed at a temperature of 50-90° C.

A third aspect of the present invention provides a battery, including the polymer-coated separator with the secondary agglomerates according to the first aspect of the present invention or the polymer-coated separator with the secondary agglomerates prepared by the preparation method according to the second aspect of the present invention.

### Beneficial Effects

according to the polymer-coated separator with the secondary agglomerates provided by the present invention, a coated separator with high adhesion, high ion permeability, high electrolyte uptake and retention, and low powder shedding rate is obtained by controlling an agglomeration state of the polymer secondary agglomerates and the distribution of the secondary agglomerates within the spray coating points. Additional aspects and advantages of the present invention will be given in part in the following description, and in part will be obvious from the following description, or will be understood by the practice of the present invention.

### BRIEF DESCRIPTION OF THE DRAWINGS

The accompanying drawings are used to provide a further understanding of the present invention and constitute a part of the description, and are used to explain the present invention together with the following specific embodiments, but do not constitute limitations on the present invention. In the drawings:

FIG. 1 is a scanning electron microscope image of a PVDF coating of a polymer-coated separator of the present invention at 200×;

FIG. 2 is a scanning electron microscope image of the PVDF coating of the polymer-coated separator of the present invention at 1000×;

FIG. 3 is a scanning electron microscope image of the PVDF coating of the polymer-coated separator of the present invention at 10000×;

FIG. 4 is a schematic view of a rotary disc of a high-speed rotary spray coater; and

FIG. 5 is a process flow diagram of a preparation method for the polymer-coated separator with the secondary agglomerates.

### DETAILED DESCRIPTION

The specific embodiments of the present invention will be described below in detail with reference to the accompanying drawings. It should be understood that the specific embodiments described herein are merely illustrative and explanatory of the present invention, and are not intended to limit the present invention.

According to a first aspect of the present invention, provided is a polymer-coated separator with secondary agglomerates, including a separator substrate, and a polymer coating applied on a surface of at least one side of the separator substrate, wherein the polymer coating includes a plurality of randomly distributed spray coating points, the spray coating points including a plurality of polymer secondary agglomerates formed by agglomeration of polymer primary particles;
any one spray coating point in the polymer coating satisfies the following conditions:

25≤A/B≤40000, and 100≤C/A≤10⁶, wherein
A represents a projected area of the polymer secondary agglomerates within the spray coating point on the separator substrate;
B represents a projected area of the polymer primary particles within the spray coating point on the separator substrate; and
C represents a projected area of the spray coating point on the separator substrate; and
n×ΣA/S means a proportion of effective bonding area on the polymer coating, and satisfies: 4%≤n×ΣA/S≤50%, wherein
S represents a surface area of the separator substrate;
ΣA represents the sum of projected areas of all polymer secondary agglomerates within the spray coating points on the separator substrate; and
n represents the number of the spray coating points within the area S.

Detailed description is given below:
the separator substrate may be an uncoated substrate or a substrate coated with an inorganic particle layer, without particular limitation.

In the examples of the present invention, the kind of the separator substrate is not particularly limited, and can be selected according to actual requirements; preferably, the separator substrate may be selected from one or more of a polyethylene film, a polypropylene film, a polyimide film, a polyvinylidene fluoride film, a polyvinylidene fluoride-hexafluoropropylene film, a polyamide film, and a polyethylene terephthalate film.

In the examples of the present invention, the kind of the inorganic particles is not particularly limited, and can be selected according to actual requirements; preferably, the inorganic particles may be selected from one or more of silica (SiO₂), alumina (Al₂O₃), magnesium oxide (MgO), zirconium oxide (ZrO2), titanium oxide (TiO2), calcium oxide (CaO), boehmite (AIOOH), aluminium nitride (AlN), boron nitride (BN), barium sulfate (BaSO₄), calcium fluoride (CaF₂), and barium fluoride (BaF₂).

The separator substrate may have a thickness of 3-25 μm, preferably 5-16 μm.

The separator substrate may have a porosity of 20-80%, preferably 30-50%.

Any one spray coating point in the polymer coating of the present invention satisfies the following conditions: 25≤A/B≤40000, and 100≤C/A≤10⁶, wherein A represents a projected area of the polymer secondary agglomerates within the spray coating point on the separator substrate; B represents a projected area of the polymer primary particles within the spray coating point on the separator substrate; and C represents a projected area of the spray coating point on the separator substrate; and
a proportion of effective bonding area on the polymer coating n×ΣA/S satisfies:
4%≤n×ΣA/S≤50%, wherein ΣA represents the sum of projected areas of all polymer secondary agglomerates within any one spray coating point within S on the separator substrate; n represents the number of the spray coating points within S; and S represents a surface area of the separator substrate.

The shapes of the secondary agglomerates and the spray coating points are not particularly limited.
1. A/B represents an aggregation state of primary particles in the polymer secondary agglomerates, when A/B>40000, the polymer secondary agglomerates are too large, and the polymer coating has uneven thickness, and is easily detached, and powder is easily shedded, affecting the local ion permeability of the separator; and when A/B≤25, the polymer secondary agglomerates are too small, the bonding strength of the polymer coating is weak, and the electrolyte uptake and retention of the separator are poor.

Wherein A represents the projected area of the polymer secondary agglomerates on the polymer coating, and a test method is as follows: a certain spray coating point is randomly selected, a picture of the spray coating point is taken by a scanning electron microscope at a magnification of 200, and an edge range of the polymer secondary agglomerates is marked by software (e.g. image processing software such as Image J), an area of the range being the projected area of the polymer secondary agglomerates on the polymer coating. A method for marking the edge range of the secondary agglomerates is as follows: a line is drawn around the edge of the secondary agglomerates from a certain point at the edge of the secondary agglomerates, requiring that all line segments have a subtended angle of less than 180⁰ (each line segment has an internal angle of less than 180° with respect to a previous line segment). When the line segments have a subtended angle of more than 180°, the line segment is disconnected and directly connected to a starting point, and the line segments are enclosed into a closed area, that is, a range, an area of which is the projected area of the secondary agglomerates.

In some examples, A ranges from 0.785-314 μm².

B represents the projected area of the polymer primary particles on the polymer coating, and a test method is as follows: a certain spray coating point is randomly selected, a picture of the spray coating point is taken by a scanning electron microscope at a magnification of 10000, and a (circular) range of the polymer primary particles can be marked by software (e.g., image processing software such as Image J), an area of the range being the projected area of the polymer primary particles on the polymer coating.

In some examples, B ranges from 7.85×10⁻³-0.785 μm².

A/B is in the range of 25≤A/B≤40000, such as 100-2500, 100-3600, 100-6000, 100-10000, 100-40000 or 200-1600, 200-3600, 200-6000, 200-40000 or 250-6000, 250-8000, 250-10000, 250-40000, etc.
2. C/A represents the distribution of the polymer secondary agglomerates within the spray coating points, when C/A≤100, the polymer secondary agglomerates within the spray coating points are too large and small in number, and the polymer coating has uneven thickness, and is easily detached, and powder is easily shedded; and when C/A>10⁶, effective polymer aggregates within the spray coating points are too few, the coating has poor adhesion properties, the electrolyte uptake and retention are poor, an exposed area of the separator substrate within the spray coating points is small, and the ion penetration performance is poor.

Wherein C represents the projected area of the spray coating point on the polymer coating, and a test method is as follows: a certain spray coating point is randomly selected, a picture of the spray coating point is taken by a scanning electron microscope at a magnification of 200, and a range of the spray coating points can be marked by software (e.g., image processing software such as Image J), an area of the range being the projected area of the spray coating point on the polymer coating.

It should be noted that the same spray coating point is selected for A, B, and C during the test.

In some examples, C ranges from 7.85×10⁻³-0.785 mm².

A is as defined above.

C/A ranges from 100≤C/A≤10⁶, such as 100-160,000, 600-200,000, 600-300,000, 800-300,000, etc.
3. n×ΣA/S means the proportion of the effective bonding area on the polymer coating, when n×ΣA/S≤4%, the effective bonding area is small and the bonding strength is low; and when n×ΣA/S>50%, the effective bonding area is large, an exposed area of the substrate is small, the separator has poor permeability, and the ion penetration performance is poor.

Wherein S represents the area of the substrate, n represents the number of the spray coating points within the area S, and a test method is that a finished separator is placed under a lens of a static CCD, a picture is taken under a field of view at a magnification of 3, and an area S of the picture and the number n of the spray coating points in the picture are calculated by image processing software.

YA is obtained by selecting any one spray coating point within the area S (preferably, a spray coating point having a D50 of 300-600 μm), testing a projected area of each secondary agglomerate according to the test method of A, and then summing the projected areas.

n×ΣA/S ranges, for example, from 10-40%, 10-30%, 10-20%, or 10-15%.

In the examples of the present invention, the polymer coating has a thickness of 0.5-10 μm, e.g., 0.5 μm, 1 μm, 2 μm, 3 μm, 4 μm, 5 μm . . . 8 μm, 9 μm or 10 μm. The thickness of the polymer coating is controlled to be in the range of 0.5-10 μm, if the thickness is too small, the adhesion properties are poor; and if the thickness is too large, the polymer coating has uneven thickness, and is easily detached, and powder is easily shedded, and the ion penetration performance is poor.

In the examples of the present invention, the polymer-coated separator has a bonding strength of 1.0 N/m or more to a ternary positive electrode, for example, the bonding strength of the polymer coating to a ternary positive electrode piece is 1 N/m . . . 4 N/m, 4.2 N/m, 4.5 N/m, 4.6 N/m, 4.8 N/m, 5 N/m, . . . .

In the examples of the present invention, the polymer-coated separator has a bonding strength of 0.5 N/m or more to a graphite negative electrode piece, for example, the bonding strength of the polymer-coated separator to the graphite negative electrode piece is 0.5 N/m . . . 4 N/m, 4.2 N/m, 4.5 N/m, 4.6 N/m, 4.8 N/m, 5 N/m, . . . .

The bonding strength of the polymer-coated separator to a battery electrode piece can be tested by using methods well known in the art. As a specific example, a test method of the bonding strength may be as follows: a polymer coating of a battery separator and the ternary positive electrode or the graphite negative electrode are stacked together, and hot-pressed with a hot press, and then the 180-degree peel strength is tested as the bonding strength by a tensile tester, wherein the tensile tester has a speed of 50 mm/min; and the conditions of the hot pressing are preferably a hot pressing temperature of 90° C., a hot pressing pressure of 6.5 MPa and a hot pressing time of 60 s.

In the examples of the present invention, the polymer-coated separator has an ionic conductivity of 80%-110%, e.g., 81%, 82%, 85%, 90% . . . or 110% of an ionic conductivity of the separator substrate.

The ionic conductivity of the separator can be tested by using methods well known in the art. As a specific example, a test method of the ionic conductivity may be as follows: the ionic conductivity of the separator may be calculated by a formula

$${σ}_{s} = \frac{d}{RsS} ,$$

wherein σₛ is a conductivity of the separator, Rs is a resistance of the separator, d is a thickness of the separator, and S is an effective area of the separator;
in the examples of the present invention, the polymer-coated separator has an electrolyte uptake rate of 70% or more, such as 70%, 80%, 90%, or 95%, and an electrolyte retention rate of 70% or more, such as 70%, 80%, 90%, or 95%; and
the electrolyte uptake rate and the electrolyte retention rate of the separator can be tested by using methods well known in the art. As a specific example, a test method for the electrolyte uptake rate and the electrolyte retention rate may be as follows:
determination is carried out with reference to QB/T 2303.11-2008 “Paste coated paper separator for batteries—Part 11: Determination of electrolyte absorbency”. A separator sample of 50 mm×50 mm is cut and weighed as m0, the separator sample is immersed in a beaker containing an electrolyte for 1 h, and taken out, the separator sample is suspended for 3 min to drip the electrolyte away, the separator sample with the electrolyte dripped away is weighed as m, and then the separator sample is allowed to stand at room temperature for 1 h, and weighed as m1. The electrolyte uptake rate X and the electrolyte retention rate Y of a separator for a lithium-ion battery can be calculated by the following formulas:

$$X = \frac{m - mo}{mo} \times 100 \%$$

$$Y = \frac{m 1 - m}{m} \times 100 \%$$

in the formulas, m0 is a mass of the separator before soaking, m is a mass of the separator after soaking, and m1 is a mass after standing at room temperature for 1 h.

In the examples of the present invention, the polymer-coated separator has a powder shedding rate of 5% or less, such as 4%, 3%, 2%, or 1%.

The powder shedding rate mainly characterizes a situation that powders fall from the sprayed-and-coated polymer coating, the powder shedding from a separator will result a decrease in the adhesion of the separator, and there is a risk of unsolid hot pressing, and a specific test method is as follows: a roll of a finished separator with sprayed-and-coated polymer is taken, and weighed as m0, and the separator is placed on a slitter for running, and weighed as m1 after being rolled, then the powder shedding rate P=(m0−m1)/m0×100%.

In the examples of the present invention, the polymer coating includes the following components: 80-100 parts by mass a polymer; 2-20 parts by mass a binder; and 0.01-3 parts by mass a dispersant.

In the examples of the present invention, the polymer with the secondary agglomerates includes at least one selected from a polyvinylidene fluoride homopolymer (PVDF), a polyvinylidene fluoride-trifluoroethylene copolymer (PVDF-TrFE), a polyvinylidene fluoride-methyl methacrylate copolymer (PVDF-PMMA), a polyvinylidene fluoride-hexafluoropropylene copolymer (PVDF-HFP), a polyvinylidene fluoride-acrylic acid copolymer, polymethyl methacrylate (PMMA), polyethylene (PE), and an acrylate polymer.

The polymer with the secondary agglomerates according to the present invention refers mainly to its solid form.

In some examples, a primary particle size of the polymer ranges from 0.1 μm to 1 μm, and a B value is controlled by selecting different types of polymers (such as PVDF resin).

In the examples of the present invention, the kind of the binder is not particularly limited, and can be selected according to actual requirements; preferably, the binder may be selected from one or more of carboxymethylcellulose, hydroxyethylcellulose, polyacrylic acid, polymethacrylic acid, polymethyl methacrylate, and an acrylonitrile multipolymer.

In the examples of the present invention, the kind of the dispersant is not particularly limited and can be selected according to actual requirements; preferably, the dispersant may be selected from one or more of an ethylene-acrylic acid copolymer, an ethylene-vinyl acetate copolymer, acrylic acid-polyurethane and polyethylene glycol.

The battery separator provided by the examples of the present invention can be used for different kinds of batteries, and thus the kind of batteries is not particularly limited and can be selected according to actual requirements. Preferably, the separator can be used in secondary batteries, particularly secondary batteries containing a liquid electrolyte, such as lithium-ion batteries, sodium-ion batteries, and the like.

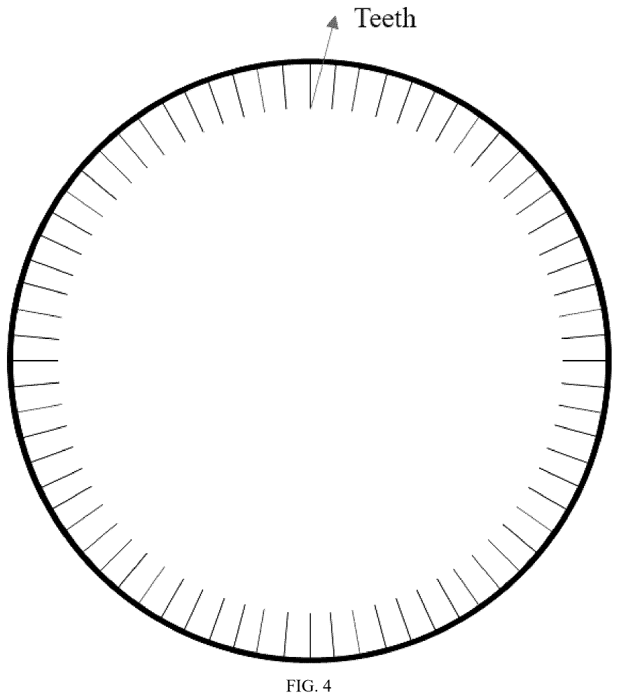

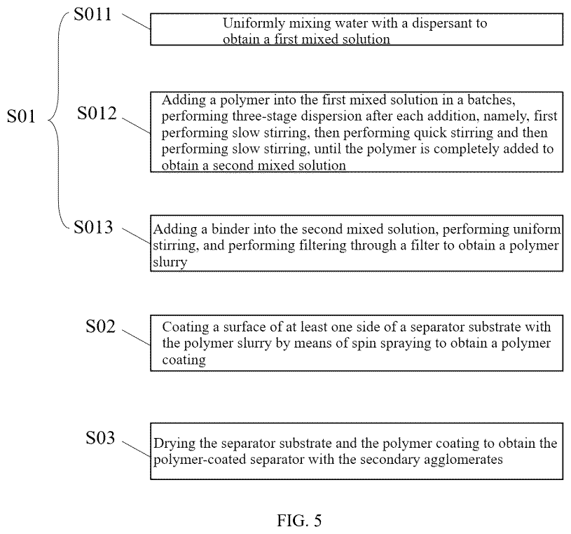

In a second aspect of the present invention, provided is a preparation method for the polymer-coated separator with the secondary agglomerates, as shown in FIG. 5, including:
S01, uniformly mixing a dispersant with water, then adding a polymer in a batches, a mass of the polymer added each time being 1/a of a total amount, each time after adding the polymer, first performing slow stirring, then performing quick stirring and then performing slow stirring, until the polymer is completely added, wherein a≥2;
optionally performing grinding treatment, finally adding a binder, and performing uniform mixing and filtering to obtain a polymer slurry;
S02, coating a surface of at least one side of a separator substrate with the polymer slurry by means of spin spraying to obtain a polymer coating with spray coating points, wherein spin spraying parameters: a coating speed of 100 m/min-300 m/min, a slurry spraying flow rate being 1500 mL/min-15000 mL/min, a rotational speed of the spraying being 5000 rpm-15000 rpm, the number of teeth of a rotary disc for the spraying being 200 teeth to 600 teeth (a schematic view of a rotary disk of a high-speed rotary spray coater is shown in FIG. 4), and a distance from the rotary disc to a membrane surface being 20 cm-50 cm; and
S03, drying the separator substrate and the polymer coating to obtain the polymer-coated separator with the secondary agglomerates.

In the examples of the present invention, the step S01 in the above preparation method may further include:
S011, uniformly mixing the water with the dispersant to obtain a first mixed solution;
S012, adding the polymer into the first mixed solution in a batches, the amount of the polymer added each time being 1/a of the total amount, after each addition, performing first-stage dispersion: wherein a stirring rotational speed is 100 rpm-600 rpm, and a stirring time is 10 min-50 min, and then performing second-stage dispersion: wherein a stirring rotational speed is 1000 rpm-2000 rpm, and a stirring time is 30 min-180 min, and finally performing third-stage dispersion: wherein a stirring rotational speed is 100 rpm-600 rpm, and a stirring time is 10 min-50 min, until the polymer is completely added to obtain a second mixed solution; and
S013, adding the binder into the second mixed solution, performing uniform stirring, and performing filtering through a 40-300-mesh filter (undispersed PVDF large particles may be sieved out by the filtering) to obtain the polymer slurry.

The addition in batches can make PVDF resin better dispersed, first slow stirring prevents the PVDF powder from being scattered during the mixing process, and then quick stirring accelerates the mixing of PVDF in the water, and a desired size of a PVDF slurry (secondary particles) can be obtained by controlling the addition times of the PVDF resin, the rotational speed and time of the slow stirring and the quick stirring, and the size of the filter, thereby adjusting the range of A/B.

In some examples, the obtained polymer slurry has a particle size D10 of 1-4 μm and a particle size D90 of 6-20 μm (controlling the range of an A value). The particle size D10 and D90 of the slurry can be tested by using a laser particle size analyzer.

The size of C is adjusted by adjusting the spray coating speed, the slurry flow rate, the number of the teeth of the rotary disc for the spraying, and the distance from the rotary disc to the membrane surface to adjust the C/A.

The proportion of the effective bonding area n×ΣA/S is adjusted by adjusting the A, and the slurry spraying flow rate.

In some examples, the resulting spray coating points have a D10 of 100 μm to 300 μm and a D90 of 800 μm to 1000 μm.

A test method for the D10 and the D90 of the spray coating points may be as follows: a finished separator is placed under a lens of a static CCD, a picture is taken under a field of view at a magnification of 3, and the number n of the spray coating points in the picture, and the size of each spray coating point are calculated by using image processing software to statistically obtain the D10 and the D90 of the spray coating points.

In the examples of the present invention, the separator substrate and a PVDF coating are treated by conventional drying.

In the examples of the present invention, the drying is performed at a temperature of 50-90° C.

According to the method provided by the second aspect of the examples of the present invention, the polymer-coated separator with the secondary agglomerates according to any example of the first aspect of the present invention may be obtained.

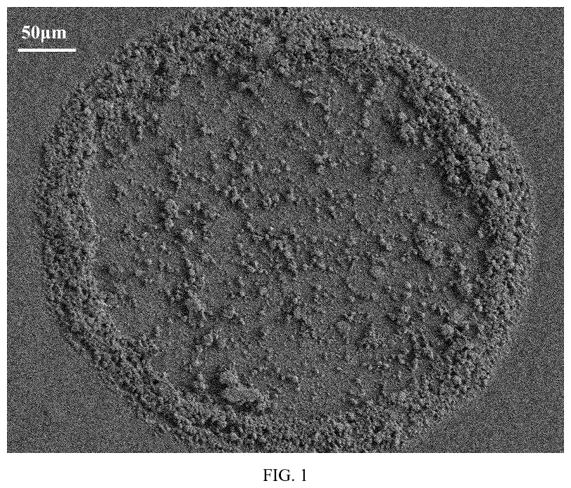

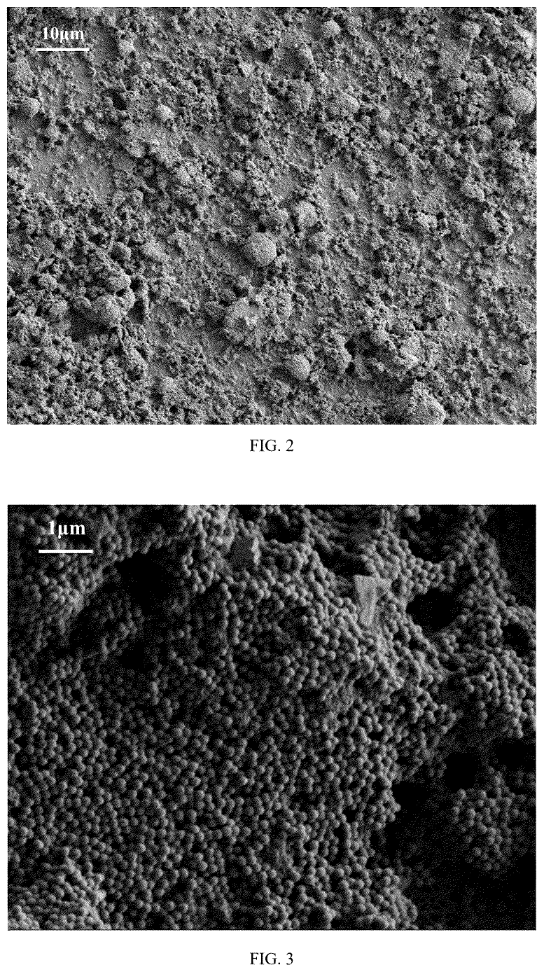

FIGS. 1 to 3 show scanning electron microscope images of the PVDF coating of the coated separator at different magnifications (an accelerating voltage EHT=1 kV, a working distance WD=5.8-6.1 mm, and using an 5E2 detector).

According to a third aspect of the present invention, provided is a battery, including the polymer-coated separator with the secondary agglomerates according to the first aspect of the examples of the present invention or the polymer-coated separator with the secondary agglomerates prepared by the preparation method according to the second aspect of the examples of the present invention.

In the examples of the present invention, the battery is a lithium-ion secondary battery or a sodium-ion secondary battery.

The present invention will be described below with reference to specific examples, and it should be understood that these examples are merely descriptive and do not limit the present invention in any way.

Unless otherwise specified, raw materials, reagents, methods and the like used in the examples are conventional raw materials, reagents, and methods in the art.

The high-speed rotary spray coater is a DS-800-01 PCS separator spray coater from Hong Kong Yuanbiao, China.

Example 1: Preparation of a water-based PVDF spraying slurry: 57 kg of water and 0.025 kg of a dispersant were weighed, and stirred at 500 rpm for 30 min to obtain a first mixed solution; 5 kg of PVDF-HFP resin (HEVER2601 having a primary particle size of 0.1-0.3 μm from HEC) was added into the first mixed solution in 2 batches, the addition amount each time being 2.5 kg, each time after addition of the PVDF-HFP resin, slow stirring was first performed at 300 rpm for 30 min, then quick stirring was performed at 1000 rpm for 60 min, and finally slow stirring was performed at 300 rpm for 20 min, until the PVDF-HFP resin was completely added to obtain a second mixed solution; and next, 0.25 kg of a polyacrylic acid binder was added into the second mixed solution, and stirring was performed at 50 rpm for 30 min to obtain a third mixed solution, and finally the third mixed solution was filtered through a 200-mesh filter to obtain the PVDF spraying slurry having a D10 of 2.1 μm, and a D90 of 7.6 μm.

Coating: the prepared PVDF spraying slurry was fed into a feeding tank of a high-speed rotary spray coater by an automatic feeding system to be applied on a surface of one side of a 9 μm polyethylene base film with a porosity of 50% which was obtained by a wet method by means of spin spraying, wherein a coating speed was 150 m/min, the number of teeth of a rotary disc for the spraying was 360, a distance from the rotary disc to a surface of the film was 25 cm, a slurry spraying flow rate was 5000 mL/min, and a rotational speed of the spraying was 9000 rpm; and drying was performed at 60° C. to obtain a water-based PVDF-coated separator.

The spray coating points obtained after coating have a D10 of 200 μm and a D90 of 800 μm.

A stacking state A/B of PVDF secondary agglomerates of the coated separator, a stacking state C/A of the spray coating points, an effective bonding area, and the performance and parameters of the separator are shown in Table 1-1 below.

Example 2: Preparation of a water-based PVDF spraying slurry: 57 kg of water and 0.0025 kg of a dispersant were weighed, and stirred at 500 rpm for 30 min to obtain a first mixed solution; 5 kg of PVDF-HFP resin (LBG having a primary particle size of 0.15-0.2 μm from a manufacturer Arkema) was added into the first mixed solution in 3 batches, the addition amount each time being 1.667 kg, each time after addition of the PVDF-HFP resin, slow stirring was first performed at 500 rpm for 30 min, then quick stirring was performed at 1500 rpm for 90 min, and finally slow stirring was performed at 500 rpm for 30 min, until the PVDF-HFP resin was completely added to obtain a second mixed solution; and next, 0.25 kg of a polyacrylic acid binder was added into the second mixed solution, and stirring was performed at 50 rpm for 30 min to obtain a third mixed solution, and finally the third mixed solution was filtered through a 300-mesh filter to obtain the PVDF spraying slurry having a D10 of 1.6 μm, and a D90 of 7.2 μm.

Coating: the prepared PVDF spraying slurry was fed into a feeding tank for spraying by an automatic feeding system to be applied on a surface of one side of a 9 μm polyethylene base film with a porosity of 50% which was obtained by a wet method by means of spin spraying, wherein a coating speed was 200 m/min, the number of teeth of a dispersion disc for the spraying was 450, a distance from a rotary disc to a separator substrate was 25 cm, a slurry spraying flow rate was 7500 mL/min, and a rotational speed of the spraying was 9000 rpm; and drying was performed at 85° C. to obtain a water-based PVDF-coated separator.

The spray coating points obtained after coating have a D10 of 150 μm and a D90 of 850 μm.

A stacking state A/B of PVDF secondary agglomerates of the coated separator, a stacking state C/A of the spray coating points, an effective bonding area, and the performance and parameters of the separator are shown in Table 1-1 below.

Example 3: Preparation of a water-based PMMA spraying slurry: 82.75 kg of water and 0.009 kg of a dispersant were weighed, and stirred at 300 rpm for 30 min to obtain a first mixed solution; 15 kg of PMMA powder (from a manufacturer Yindile, having a primary particle size of 0.2-0.5 μm) was added into the first mixed solution in 3 batches, the addition amount each time being 5 kg, each time after addition of the PMMA powder, slow stirring was first performed at 400 rpm for 30 min, then quick stirring was performed at 1200 rpm for 80 min, and finally slow stirring was performed at 500 rpm for 30 min, until the PMMA powder was completely added to obtain a second mixed solution; and next, 2.25 kg of a polyacrylic acid binder (having a solid content of 40%) was added into the second mixed solution, and stirring was performed at 20 rpm for 30 min to obtain a third mixed solution, and finally the third mixed solution was filtered through a 150-mesh filter to obtain the water-based PMMA spraying slurry having a D10 of 1.7 μm and a D90 of 14.1 μm.

Coating: the prepared spraying slurry was fed into a feeding tank for spraying by an automatic feeding system to be applied on a surface of one side of a 9 μm polyethylene base film with a porosity of 50% which was obtained by a wet method by means of spin spraying, wherein a coating speed was 150 m/min, the number of teeth of a dispersion disc for the spraying was 360, a distance from a rotary disc to a separator substrate was 25 cm, a slurry spraying flow rate was 4000 mL/min, and a rotational speed of the spraying was 9000 rpm; and drying was performed at 80° C. to obtain a water-based PMMA-coated separator.

The spray coating points obtained after coating have a D10 of 210 μm and a D90 of 800 μm.

A stacking state A/B of PMMA secondary agglomerates of the coated separator, a stacking state C/A of the spray coating points, an effective bonding area, and the performance and parameters of the separator are shown in Table 1-1 below.

Example 4: Preparation of a water-based PVDF-PMMA copolymer spraying slurry: 45 kg of water and 0.015 kg of a dispersant were weighed, and stirred at 500 rpm for 30 min to obtain a first mixed solution; 5 kg of PVDF-PMMA powder (having a primary particle size of 0.2-0.4 μm) was added into the first mixed solution in 2 batches, the addition amount each time being 2.5 kg, each time after addition of the PMMA powder, slow stirring was first performed at 600 rpm for 30 min, then quick stirring was performed at 1800 rpm for 100 min, and finally slow stirring was performed at 600 rpm for 30 min, until the PVDF-PMMA powder was completely added to obtain a second mixed solution; and next, 1.25 kg of a polyacrylic acid binder (having a solid content of 40%) was added into the second mixed solution, and stirring was performed at 20 rpm for 30 min to obtain a third mixed solution, and finally the third mixed solution was filtered through a 100-mesh filter to obtain the water-based PVDF-PMMA spraying slurry having a D10 of 2.3 μm and a D90 of 12.5 μm.

Coating: the prepared spraying slurry was fed into a feeding tank for spraying by an automatic feeding system to be applied on a ceramic membrane surface of a 7+2 ceramic coated membrane by means of spin spraying, wherein 7 refers to a 7 μm polyethylene base membrane with a porosity of 40% which is obtained by a wet method, and 2 refers to a ceramic coating of 2 μm, a coating speed was 100 m/min, the number of teeth of a dispersion disc for the spraying was 360, a distance from a rotary disc to a separator substrate was 25 cm, a slurry spraying flow rate was 2200 mL/min, and a rotational speed of the spraying was 8500 rpm; and drying was performed at 65° C. to obtain a water-based PVDF-PMMA-coated separator.

The spray coating points obtained after coating have a Dl 0 of 230 μm and a D90 of 820 μm.

A stacking state A/B of PVDF-PMMA secondary agglomerates of the coated separator, a stacking state C/A of the spray coating points, an effective bonding area, and the performance and parameters of the separator are shown in Table 1-1 below.

Example 5: Preparation of a water-based PVDF-PMMA copolymer spraying slurry: the same as that in Example 4.

Coating: the prepared spraying slurry was fed into a feeding tank for spraying by an automatic feeding system to be applied on both sides of a 7+2 ceramic coated membrane by means of spin spraying, wherein 7 refers to a 7 μm polyethylene base membrane with a porosity of 40% which is obtained by a wet method, and 2 refers to a ceramic coating of 2 μm, a coating speed was 100 m/min, the number of teeth of a dispersion disc for the spraying was 360, a distance from a rotary disc to a separator substrate was 25 cm, a slurry spraying flow rate was 2200 mL/min, and a rotational speed of the spraying was 8500 rpm; and drying was performed at 65° C. to obtain a water-based PVDF-PMMA-coated separator.

The spray coating points obtained after coating have a Dl 0 of 230 μm and a D90 of 820 μm.

A stacking state A/B of PVDF-PMMA secondary agglomerates of the coated separator, a stacking state C/A of the spray coating points, an effective bonding area, and the performance and parameters of the separator are shown in Table 1-1 below.

Comparative example 1: Preparation of a water-based PVDF spraying slurry: 52 kg of water and 0.3 kg of a dispersant were weighed, and stirred for 30 min to obtain a first mixed solution; 20 kg of a PVDF-HFP emulsion (having a primary particle size of 0.15-0.2 μm) having a solid content of 30% was added into the first mixed solution, and uniform mixing was performed under stirring at 200 rpm for 30 min to obtain a second mixed solution; and 0.5 kg of a polyacrylic acid binder was added into the second mixed solution, and stirring was performed for 30 min to obtain the PVDF spraying slurry having a D10 of 0.15 μm and a D90 of 0.6 μm.

Coating: the prepared PVDF spraying slurry was fed into a feeding tank for spraying by an automatic feeding system to be applied on a surface of one side of a 12 μm polyethylene base film with a porosity of 50% which was obtained by a wet method by means of spin spraying, wherein a coating speed was 100 m/min, the number of teeth of a dispersion disc for the spraying was 450, a distance from a rotary disc to a separator substrate was 30 cm, a slurry spraying flow rate was 3200 mL/min, and a rotational speed of the spraying was 7200 rpm; and drying was performed at 85° C. to obtain a water-based PVDF-coated separator.

The spray coating points obtained after coating have a Dl 0 of 100 μm and a D90 of 600 μm.

A stacking state A/B of PVDF secondary agglomerates of the coated separator, a stacking state C/A of the spray coating points, an effective bonding area, and the performance and parameters of the separator are shown in Table 1-2 below.

Comparative example 2: Preparation of a water-based PVDF spraying slurry: 57 kg of water and 0.0025 kg of a dispersant were weighed, and stirred for 30 min to obtain a first mixed solution; 5 kg of PVDF resin powder (having a primary particle size of 0.15-0.2 μm) was added into the first mixed solution, slow stirring was first performed at 200 rpm for 50 min, then stirring was performed at 600 rpm for 60 min, and finally stirring was performed at 200 rpm for 30 min to be uniformly mixed to obtain a second mixed solution, then 0.25 kg of a polyacrylic acid binder was added into the second mixed solution, and then stirring was performed at 50 rpm for 30 min to obtain a third mixed solution, without filtering, the obtained PVDF spraying slurry having a D10 of 3.8 μm and a D90 of 35 μm.

Coating: the prepared PVDF spraying slurry was fed into a feeding tank for spraying by an automatic feeding system to be applied on a surface of one side of a 9 μm polyethylene base film with a porosity of 50% which was obtained by a wet method by means of spin spraying, wherein a coating speed was 150 m/min, the number of teeth of a dispersion disc for the spraying was 450, a distance from a rotary disc to a separator substrate was 25 cm, a slurry spraying flow rate was 5000 mL/min, and a rotational speed of the spraying was 12000 rpm.

The spray coating points have a Dl 0 of 80 μm and a D90 of 600 μm.

A stacking state A/B of PVDF secondary agglomerates of the coated separator, a stacking state C/A of the spray coating points, an effective bonding area, and the performance and parameters of the separator are shown in Table 1-2 below.

Comparative example 3: Preparation of a water-based PVDF spraying slurry: the same as that in Example 1.

Coating: the prepared PVDF spraying slurry was applied on a surface of one side of a 9 μm polyethylene base film with a porosity of 50% which was obtained by a wet method by means of spin spraying, wherein a coating speed was 200 m/min, the number of teeth of a dispersion disc for the spraying was 800, a distance from a rotary disc to a separator substrate was 25 cm, a slurry spraying flow rate was 9000 mL/min, and a rotational speed of the spraying was 17000 rpm; and drying was performed at 85° C. to obtain a polymer-coated separator with secondary agglomerates.

The spray coating points obtained after coating have a D10 of 50 μm and a D90 of 300 μm.

A stacking state A/B of PVDF secondary agglomerates of the coated separator, a stacking state C/A of the spray coating points, an effective bonding area, and the performance and parameters of the separator are shown in Table 1-2 below.

Comparative example 4: Preparation of a water-based PVDF spraying slurry: 57 kg of water and 0.0025 kg of a dispersant were weighed, and stirred at 500 rpm for 30 min to obtain a first mixed solution; 5 kg of PVDF-HFP resin (having a primary particle size of 0.15-0.2 μm) was added into the first mixed solution in 5 batches, the addition amount each time being 1 kg, each time after addition of the PVDF-HFP resin, slow stirring was performed at 500 rpm for 30 min, then quick stirring was performed at 2500 rpm for 100 min, and finally slow stirring was performed at 500 rpm for 30 min, the above operations were repeated until the PVDF-HFP resin was completely and uniformly mixed to obtain a second mixed solution; and next, 0.25 kg of a polyacrylic acid binder was added into the second mixed solution, and stirring was performed at 50 rpm for 30 min to obtain a third mixed solution, and finally the third mixed solution was filtered through a 300-mesh filter to obtain the PVDF spraying slurry having a Dl 0 of 1.2 μm and a D90 of 5.6 μm.

Coating: the prepared PVDF spraying slurry was applied on a surface of one side of a 9 μm polyethylene base film with a porosity of 50% which was obtained by a wet method by means of spin spraying, wherein a coating speed was 200 m/min, the number of teeth of a dispersion disc for the spraying was 280, a distance from a rotary disc to a separator substrate was 25 cm, a slurry spraying flow rate was 6000 mL/min, and a rotational speed of the spraying was 4000 rpm. Drying was performed at 85° C. to obtain a polymer-coated separator with secondary agglomerates, the obtained spray coating points having a D10 of 350 μm and a D90 of 1500 μm.

A stacking state A/B of PVDF secondary agglomerates of the coated separator, a stacking state C/A of the spray coating points, an effective bonding area, and the performance and parameters of the separator are shown in Table 1-2 below.

Comparative example 5: Preparation of a water-based PVDF spraying slurry: the same as that in Comparative example 2.

Coating: the same as that in Comparative example 3.

A stacking state A/B of PVDF secondary agglomerates of the coated separator, a stacking state C/A of the spray coating points, an effective bonding area, and the performance and parameters of the separator are shown in Table 1-2 below.

Comparative example 6: Preparation of a water-based PVDF spraying slurry: the same as that in Comparative example 4.

Coating: the prepared PVDF spraying slurry was applied on a surface of one side of a 9 μm polyethylene base film with a porosity of 50% which was obtained by a wet method by means of spin spraying, wherein a coating speed was 300 m/min, the number of teeth of a dispersion disc for the spraying was 180, a distance from a rotary disc to a separator substrate was 15 cm, a slurry spraying flow rate was 16000 mL/min, and a rotational speed of the spraying was 4500 rpm. Drying was performed at 85° C. to obtain a polymer-coated separator with secondary agglomerates, the obtained spray coating points having a D10 of 450 μm and a D90 of 2000 μm.

A stacking state A/B of PVDF secondary agglomerates of the coated separator, a stacking state C/A of the spray coating points, an effective bonding area, and the performance and parameters of the separator are shown in Table 1-3 below.

Comparative example 7: Preparation of a water-based PVDF spraying slurry: the same as that in Comparative example 2.

Coating: the prepared PVDF spraying slurry was applied on a surface of one side of a 9 μm polyethylene base film with a porosity of 50% which was obtained by a wet method by means of spin spraying, wherein a coating speed was 150 m/min, the number of teeth of a dispersion disc for the spraying was 300, a distance from a rotary disc to a separator substrate was 15 cm, a slurry spraying flow rate was 1000 mL/min, and a rotational speed of the spraying was 6000 rpm. Drying was performed at 80° C. to obtain a polymer-coated separator with secondary agglomerates, the obtained spray coating points having a D10 of 220 μm and a D90 of 1000 μm.

A stacking state A/B of PVDF secondary agglomerates of the coated separator, a stacking state C/A of the spray coating points, an effective bonding area, and the performance and parameters of the separator are shown in Table 1-3 below.

### Test Section

The PVDF coatings and battery separators in the above Examples 1-5 and Comparative examples 1-7 were subjected to relevant performance tests, and the test results are shown in Tables 1-1, 1-2, and 1-3 below.

TABLE 1-1

| Item | Unit | Example 1 | Example 2 | Example 3 | Example 4 | Example 5 |
|---|---|---|---|---|---|---|
| Primary | μm | 0.1-0.3 | 0.15-0.2 | 0.2-0.5 | 0.2-0.4 | 0.2-0.4 |
| particle size | | | | | | |
| D10 of | μm | 2.1 | 1.6 | 1.7 | 2.3 | 2.3 |
| slurry | | | | | | |
| D90 of | μm | 7.6 | 7.2 | 14.1 | 12.5 | 12.5 |
| slurry | | | | | | |
| D10 of spray | μm | 200 | 150 | 210 | 230 | 230 |
| coating point | | | | | | |
| D90 of spray | μm | 800 | 850 | 800 | 820 | 820 |
| coating point | | | | | | |
| A/B | / | 110-5770 | 110-2300 | 81-4970 | 58-3900 | 58-3900 |
| C/A | / | 692-1.4×10⁵ | 416-2.82×10⁵ | 221-2.2×10⁵ | 400-1.2×10⁵ | 400-1.2×10⁵ |
| Coating | g/m² | 0.6 | 0.6 | 0.6 | 0.3 | 0.3 |
| amount | | | | | | |
| Coating | μm | 4 | 3.2 | 5.1 | 2.2 | 2.2 |
| thickness | | | | | | |
| Proportion | % | 12 | 10.5 | 12 | 7 | 7 |
| of effective | | | | | | |
| bonding area | | | | | | |
| Bonding | N/m | 6 | 6.6 | 22.4 | 5.9 | 5.9 |
| strength to | | | | | | |
| positive | | | | | | |
| electrode | | | | | | |
| Bonding | N/m | 1.5 | 1.9 | 15.8 | 3.7 | 3.7 |
| strength to | | | | | | |
| negative | | | | | | |
| electrode | | | | | | |
| Powder | % | 1.2 | 0.9 | 2.8 | 0.5 | 0.5 |
| shedding | | | | | | |
| rate | | | | | | |
| Ionic | % | 97 | 96 | 95 | 92 | 84 |
| conductivity | | | | | | |
| of | | | | | | |
| separator/ | | | | | | |
| ionic | | | | | | |
| conductivity | | | | | | |
| of substrate | | | | | | |
| Electrolyte | % | 85 | 88 | 94 | 90 | 95 |
| uptake rate | | | | | | |
| Electrolyte | % | 80 | 85 | 89 | 86 | 85 |
| retention | | | | | | |
| rate | | | | | | |

TABLE 1-2

| | | Comparative | Comparative | Comparative | Comparative | Comparative |
|---|---|---|---|---|---|---|
| Item | Unit | example 1 | example 2 | example 3 | example 4 | example 5 |
| Primary | μm | 0.15-0.2 | 0.15-0.2 | 0.1-0.3 | 0.15-0.2 | 0.15-0.2 |
| particle size | | | | | | |
| D10 of | μm | 0.15 | 3.8 | 2.1 | 0.8 | 3.8 |
| slurry | | | | | | |
| D90 of | μm | 0.6 | 35 | 7.6 | 5.6 | 35 |
| slurry | | | | | | |
| D10 of | μm | 100 | 80 | 50 | 350 | 50 |
| spray | | | | | | |
| coating | | | | | | |
| point | | | | | | |
| D90 of | μm | 600 | 600 | 300 | 1500 | 300 |
| spray | | | | | | |
| coating | | | | | | |
| point | | | | | | |
| A/B | / | 1-16 | 360-54300 | 110-5770 | 64-1390 | 360-54300 |
| C/A | / | 2.8×10⁴- | 100-2.49× | 42-2.3× | 3900- | 25-6200 |
| | | 1.6×10⁷ | 10⁴ | 10⁴ | 1.5×10⁶ | |
| Coating | g/m² | 0.6 | 0.6 | 0.6 | 0.6 | 0.6 |
| amount | | | | | | |
| Coating | μm | 1.0 | 10 | 7 | 1.7 | 15 |
| thickness | | | | | | |
| Proportion | % | 30 | 9 | 24 | 18 | 23 |
| of effective | | | | | | |
| bonding | | | | | | |
| area | | | | | | |
| Bonding | N/m | 7.2 | 1.5 | 5.1 | 3.7 | 1.7 |
| strength to | | | | | | |
| positive | | | | | | |
| electrode | | | | | | |
| Bonding | N/m | 1.2 | 0.2 | 0.9 | 0.9 | 0.2 |
| strength to | | | | | | |
| negative | | | | | | |
| electrode | | | | | | |
| Powder | % | 0.5 | 6 | 5.2 | 0.8 | 10 |
| shedding | | | | | | |
| rate | | | | | | |
| Ionic | % | 70 | 75 | 73 | 75 | 67 |
| conductivity | | | | | | |
| of | | | | | | |
| separator/ | | | | | | |
| ionic | | | | | | |
| conductivity | | | | | | |
| of | | | | | | |
| substrate | | | | | | |
| Electrolyte | % | 76 | 90 | 92 | 80 | 93 |
| uptake rate | | | | | | |
| Electrolyte | % | 71 | 88 | 89 | 73 | 90 |
| retention | | | | | | |
| rate | | | | | | |

TABLE 1-3

| | | Comparative | Comparative |
|---|---|---|---|
| Item | Unit | example 6 | example 7 |
| Primary particle size | μm | 0.15-0.2 | 0.15-0.2 |
| D10 of slurry | μm | 1.2 | 3.8 |
| D90 of slurry | μm | 5.6 | 35 |
| D10 of spray coating point | μm | 450 | 220 |
| D90 of spray coating point | μm | 2000 | 1000 |
| A/B | / | 64-1390 | 360-54300 |
| C/A | / | 1600-2.7 × 10⁶ | 38-6.9 × 10³ |
| Coating amount | g/m² | 1.8 | 0.12 |
| Coating thickness | μm | 2.0 | 3.2 |
| Proportion of effective bonding area | % | 78 | 2.5 |
| Bonding strength to positive electrode | N/m | 12 | 0.5 |
| Bonding strength to negative | N/m | 7.1 | 0.1 |
| electrode | | | |
| Powder shedding rate | % | 3 | 8 |
| Ionic conductivity of separator/ionic | % | 65 | 90 |
| conductivity of substrate | | | |
| Electrolyte uptake rate | % | 85 | 77 |
| Electrolyte retention rate | % | 82 | 72 |

As can be seen from the results of the examples and the comparative examples, in Examples 1-5, A/B, C/A, and n×ΣA/S are all within a given range, and the adhesion properties, the ionic conductivity, the electrolyte uptake/retention rate and the powder shedding rate can be effectively balanced to achieve the optimal effect; in Comparative example 1, the PVDF-HFP emulsion was used, there was no secondary agglomerate structure, A/B was small and C/A was large, and although the adhesion properties were high, the ionic conductivity and the electrolyte uptake and retention are poor; in Comparative example 2, one-time feeding and dispersion were performed during preparation of the slurry, and the stirring rotational speed was excessively small, the dispersion performance of the powder in the water was poor, and finally the slurry was not treated by filtration, so PVDF particles in the slurry were large in particle size and wide in distribution range, A/B was large, C/A was normal, the adhesion properties and ion permeability were poor, the powder shedding rate was significantly increased, and powder shedding of the coating was severe; in Comparative example 3, the secondary agglomerates were normal, the dispersion disc with 800 teeth was used, the rotational speed of the spraying was 17000 rpm, so that the spray coating points were excessively small, A/B was normal, C/A was small, the stacking of the spray coating points was high, the bonding strength had no obvious change, but the ionic conductivity was obviously decreased, and the powder shedding rate was increased; in Comparative example 4, the PVDF powder was added in 5 batches during slurry preparation, stirring was performed at a ultra high speed, the PVDF secondary agglomerates were obtained, the rotational speed was low, the number of the teeth of the rotary disc was small, the spray coating points were large, A/B was small, C/A was large, both the adhesion and the ionic conductivity were decreased, and the electrolyte uptake rate and the electrolyte retention rate were significantly decreased; in Comparative example 5, the secondary agglomerates were large, the spray coating points were small, A/B was large, C/A was small, both the adhesion and the ionic conductivity became worse, and the powder shedding rate was significantly improved; in Comparative example 6, the spraying flow rate was excessively large, the number of the teeth of the rotary disc was excessively small, the coating amount was high, and the spray coating points were excessively large, so that n×ΣA/S was excessively large, and the ion conductivity was significantly decreased; and in Comparative example 7, the spraying flow rate was excessively small, the particle size of the slurry was excessively large, and the coating amount was small, so that n×ΣA/S was excessively small, and the bonding strength of the coating to the positive electrode piece and the negative electrode piece was significantly decreased.

As can be seen from the results of the examples and the comparative examples, the polymer-coated separator has high adhesion, high ion permeability, high electrolyte uptake and retention, and low powder shedding rate only when A/B, C/A and nxjA/S are all within the given range. Although the examples of the present invention have been shown and described above, it will be appreciated that the above examples are illustrative and not to be construed as limiting the present invention. Those of ordinary skill in the art may make changes, modifications, substitutions, and variations to the above examples within the scope of the present invention.

1. A polymer-coated separator with secondary agglomerates, characterized by comprising:
a separator substrate, and
a polymer coating applied on a surface of at least one side of the separator substrate, wherein
the polymer coating comprises a plurality of randomly distributed spray coating points, the spray coating points comprising a plurality of polymer secondary agglomerates formed by agglomeration of polymer primary particles;
any one spray coating point in the polymer coating satisfies the following conditions:
25≤A/B≤40000, and 100≤C/A≤10⁶, wherein
A represents a projected area of the polymer secondary agglomerates within the spray coating point on the separator substrate;
B represents a projected area of the polymer primary particles within the spray coating point on the separator substrate; and
C represents a projected area of the spray coating point on the separator substrate; and
n×ΣA/S means a proportion of effective bonding area on the polymer coating, and satisfies: 4%≤n×ΣA/S≤50%, wherein
S represents a surface area of the separator substrate;
ΣA represents the sum of projected areas of all polymer secondary agglomerates within the spray coating points on the separator substrate; and
n represents the number of the spray coating points within the area S.

2. The polymer-coated separator with the secondary agglomerates according to claim 1, characterized in that 25≤A/B≤10000, and 2500≤C/A≤5×10⁵; and
$$6 \% \leq n \times Σ A / S \leq 30 \% .$$

3. The polymer-coated separator with the secondary agglomerates according to claim 1, characterized in that the polymer-coated separator has a bonding strength of 1 N/m or more to a ternary positive electrode, and has a bonding strength of 0.5 N/m or more to a graphite negative electrode; and/or
the polymer-coated separator has an ionic conductivity of 80%-110% of an ionic conductivity of the separator substrate; and/or
the polymer-coated separator has an electrolyte uptake rate of 70% or more, and an electrolyte retention rate of 70% or more; and/or
the polymer-coated separator has a powder shedding rate of 5% or less.

4. The polymer-coated separator with the secondary agglomerates according to claim 1, characterized in that the polymer coating comprises:
80-100 parts by mass a polymer with secondary agglomerates;
2-20 parts by mass a binder; and
0.01-3 parts by mass a dispersant.

5. The polymer-coated separator with the secondary agglomerates according to claim 4, characterized in that the polymer with the secondary agglomerates comprises at least one selected from a polyvinylidene fluoride homopolymer, a polyvinylidene fluoride-trifluoroethylene copolymer, a polyvinylidene fluoride-methyl methacrylate copolymer, a polyvinylidene fluoride-hexafluoropropylene copolymer, a polyvinylidene fluoride-acrylic acid copolymer, polymethyl methacrylate, polyethylene, and an acrylate polymer; and/or
the binder comprises at least one selected from carboxymethylcellulose, hydroxyethylcellulose, polyacrylic acid, polymethacrylic acid, polymethyl methacrylate, and an acrylonitrile multipolymer; and/or
the dispersant comprises at least one selected from an ethylene-acrylic acid copolymer, an ethylene-vinyl acetate copolymer, acrylic acid-polyurethane, and polyethylene glycol.

6. The polymer-coated separator with the secondary agglomerates according to claim 1, characterized in that the separator substrate has a thickness of 3-25 μm, and a porosity of 20-80%; and/or the polymer coating has a thickness of 0.5-10 μm.

7. A preparation method for the polymer-coated separator with the secondary agglomerates according to claim 1, characterized by comprising:
S01, uniformly mixing a dispersant with water, then adding a polymer in a batches, a mass of the polymer added each time being 1/a of a total amount, each time after adding the polymer, first performing slow stirring, then performing quick stirring and then performing slow stirring, until the polymer is completely added, wherein a≥2; finally adding a binder, and performing uniform mixing and filtering to obtain a polymer slurry;
the step S01 comprises:
S011, uniformly mixing the water with the dispersant to obtain a first mixed solution;
S012, adding the polymer into the first mixed solution in a batches, the amount of the polymer added each time being 1/a of the total amount, after each addition, performing first-stage dispersion: wherein a stirring rotational speed is 100 rpm-600 rpm, and a stirring time is 10 min-50 min, and then performing second-stage dispersion: wherein a stirring rotational speed is 1000 rpm-2000 rpm, and a stirring time is 30 min-180 min, and finally performing third-stage dispersion: wherein a stirring rotational speed is 100 rpm-600 rpm, and a stirring time is 10 min-50 min, until the polymer is completely added to obtain a second mixed solution; and
S013, adding the binder into the second mixed solution, performing uniform stirring, and performing filtering through a 40-300-mesh filter to obtain the polymer slurry;
S02, coating a surface of at least one side of a separator substrate with the polymer slurry by means of spin spraying to obtain a polymer coating, wherein spin spraying parameters: a coating speed of 100 m/min-300 m/min, a slurry spraying flow rate being 1500 mL/min-15000 mL/min, a rotational speed of the spraying being 5000 rpm-15000 rpm, the number of teeth of a rotary disc for the spraying being 200 teeth to 600 teeth, and a distance from the rotary disc to a membrane surface being 20 cm-50 cm; and
S03, drying the separator substrate and the polymer coating to obtain the polymer-coated separator with the secondary agglomerates.

8. The preparation method for the polymer-coated separator with the secondary agglomerates according to claim 7, characterized in that the polymer slurry has a particle size D10 of 1-4 μm and a particle size D90 of 6-20 μm.

9. The preparation method for the polymer-coated separator with the secondary agglomerates according to claim 7, characterized in that the polymer coating amount is 0.05-1.5 g/m².

10. The preparation method for the polymer-coated separator with the secondary agglomerates according to claim 7, characterized in that in the step S01, after the polymer is completely added, grinding treatment is performed, finally the binder is added, and uniform mixing and filtering are performed to obtain the polymer slurry.

11. A battery, comprising the polymer-coated separator with the secondary agglomerates according to claim 1.

12. A battery, comprising the polymer-coated separator with the secondary agglomerates according to claim 2.

13. A battery, comprising the polymer-coated separator with the secondary agglomerates according to claim 3.

14. A battery, comprising the polymer-coated separator with the secondary agglomerates according to claim 4

15. A battery, comprising the polymer-coated separator with the secondary agglomerates according to claim 5.

16. A battery, comprising the polymer-coated separator with the secondary agglomerates according to claim 6.
